(19) United States
(12) Patent Application Publication
(10) Pub. No.: US 2024/0128571 A1
(43) Pub. Date: Apr. 18, 2024

(54) BATTERY PACK

(71) Applicant: TOYOTA JIDOSHA KABUSHIKI KAISHA, Toyota-shi (JP)

(72) Inventors: Hirotaka WATANABE, Toyota-shi (JP); Masahiro YAMADA, Nagoya-shi (JP); Akiya KUBOTA, Toyota-shi (JP)

(73) Assignee: TOYOTA JIDOSHA KABUSHIKI KAISHA, Toyota-shi (JP)

(21) Appl. No.: 18/449,274

(22) Filed: Aug. 14, 2023

(30) Foreign Application Priority Data
Oct. 17, 2022 (JP) 2022-166232

(51) Int. Cl. H01M 50/24; H01M 50/209; H01M 50/505

(52) U.S. Cl. CPC H01M 50/24; H01M 50/209; H01M 50/505; H01M 2220/20

(57) ABSTRACT

The battery pack includes a tray having a bottom wall, a cell module disposed on the tray and having at least one battery cell, a high voltage connection portion provided on the bottom surface of the cell module and electrically connected to the at least one battery cell, a high voltage busbar connected to the high voltage connection portion, and a water absorbing sheet disposed between the bottom wall of the tray and the bottom surface of the cell module. A first opening portion is defined in the water absorbing sheet at a position opposite the high voltage connection portion.

### CROSS-REFERENCE TO RELATED APPLICATION

This application claims priority to Japanese Patent Application No. 2022-166232 filed on Oct. 17, 2022, incorporated herein by reference in its entirety.

### BACKGROUND

### 1. Technical Field

The technique disclosed in the present specification relates to a battery pack.

### 2. Description of Related Art

Japanese Unexamined Patent Application Publication No. 2013-65419 (JP 2013-65419 A) discloses a battery pack including a tray provided with a bottom wall, a cell module that is disposed on the tray and that includes at least one battery cell, and a water absorbing sheet disposed between the bottom wall of the tray and a bottom surface of the cell module.

### SUMMARY

In a battery pack, a high voltage connection portion that is electrically connected to at least one battery cell may be provided on a bottom surface of the cell module. In the battery pack having such a configuration, it is assumed that the water absorbing sheet is disposed at a position facing the high voltage connection portion, that is, the water absorbing sheet is in contact with the high voltage connection portion. In this case, water absorbed by the water absorbing sheet comes into contact with the high voltage connection portion.

In the present specification, there is provided a technique capable of suppressing water from contacting a high voltage connection portion of a battery pack.

In a first aspect of the present technique, a battery pack includes: a tray including a bottom wall; a cell module that is disposed on the tray and includes at least one battery cell; a high voltage connection portion that is provided on a bottom surface of the cell module and that is electrically connected to the at least one battery cell; a high voltage busbar connected to the high voltage connection portion; and a water absorbing sheet disposed between the bottom wall of the tray and the bottom surface of the cell module. A first opening portion is defined in the water absorbing sheet at a position facing the high voltage connection portion. In the present specification, the term “high voltage” means an operating voltage exceeding a direct current (DC) 60V or an operating voltage exceeding an alternating current (AC) 30V (effective value).

According to the above configuration, the water absorbing sheet is not disposed at a position facing the high voltage connection portion. That is, the water absorbing sheet is not in contact with the high voltage connection portion. Therefore, it is possible to suppress the water absorbed by the water absorbing sheet from coming into contact with the high voltage connection portion.

In a second aspect of the present technique, in the first aspect, the first opening portion may surround the high voltage connection portion via a gap.

According to the above-described configuration, it is possible to reduce the possibility that the water absorbed by the water absorbing sheet comes into contact with the high voltage connection portion as compared with a configuration in which the first opening portion surrounds the high voltage connection portion without the gap.

In a third aspect of the present technique, in the first aspect or the second aspect, the tray may include an engaging member that projects upward from the bottom wall. A second opening portion that engages with the engaging member may be defined on the water absorbing sheet.

According to the above configuration, it is possible to suppress the position of the first opening portion of the water absorbing sheet with respect to the high voltage connection portion from being displaced, and it is possible to further suppress the water absorbed by the water absorbing sheet from coming into contact with the high voltage connection portion.

According to a fourth aspect of the present technique, in any one of the first to third aspects, the tray includes a positioning rib that protrudes upward from the bottom wall and that may be disposed in a portion around the high voltage connection portion. The positioning rib may be inserted into the first opening portion of the water absorbing sheet.

According to the above configuration, the positioning rib of the tray can be used to align the first opening portion of the water absorbing sheet with respect to the high voltage connection portion. In addition, it is possible to suppress the position of the first opening portion of the water absorbing sheet from being displaced with respect to the high voltage connection portion. Therefore, it is possible to further suppress the water absorbed by the water absorbing sheet from coming into contact with the high voltage connection portion.

In a fifth aspect of the present technique, in any one of the first to fourth aspects, the water absorbing sheet may be a non-woven fabric.

According to the above configuration, it is possible to firmly absorb water on the water absorption tray.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically showing a battery pack 2 according to an embodiment;

FIG. 2 is a perspective view schematically showing the tray 10 of the embodiment;

FIG. 3 is a cross-sectional view schematically showing a cross section along the broken line III-III of FIG. 1.

### DETAILED DESCRIPTION OF EMBODIMENTS

### Embodiment

A battery pack 2 of an embodiment will be described with reference to the drawings. The battery pack 2 of the present embodiment is employed in, for example, an electrified vehicle, and supplies electric power to a traveling motor that drives wheels. Electrified vehicle herein includes, but is not limited to, a battery-type electrified vehicle, a hybrid electrified vehicle, a plug-in hybrid electrified vehicle, and a fuel cell electrified vehicle. The battery pack 2 is disposed below the floor of electrified vehicle.

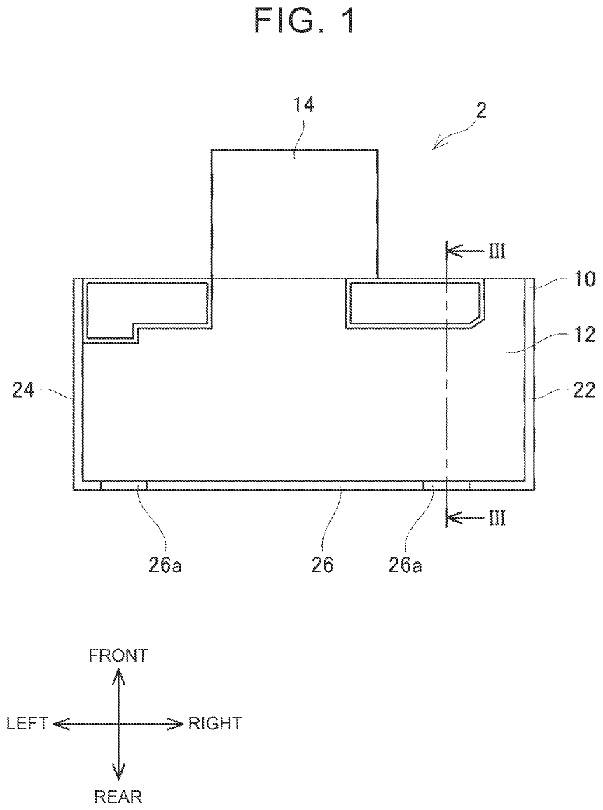

As illustrated in FIG. 1, the battery pack 2 includes a tray 10, a battery cell case 12, and an electric unit case 14. The battery cell case 12 is disposed on the tray 10. The electric unit case 14 is connected to a central portion of the battery cell case 12 in the left-right direction. The electric unit case 14 extends forward from the battery cell case 12.

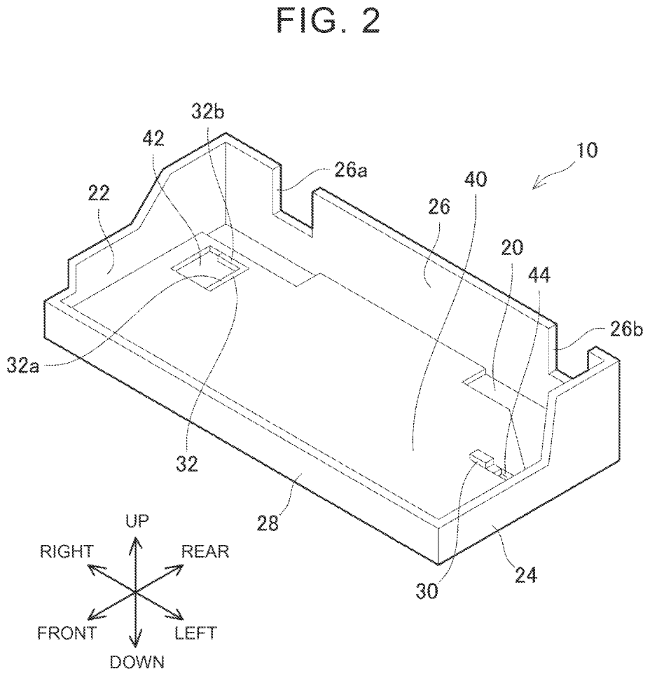

As illustrated in FIG. 2, the tray 10 includes a bottom wall 20, a right wall 22, a left wall 24, a rear wall 26, and a front wall 28. A right cutout portion 26a recessed downward is formed at a right end portion of the rear wall 26. A left cutout portion 26b recessed downward is formed at a left end portion of the rear wall 26. The right cutout portion 26a and the left cutout portion 26b are openings through which the fastening members pass. The fastening member is for fastening the bracket to the battery cell case 12. The bracket is connecting the body of electrified vehicle and the battery cell case 12 (see FIG. 1).

The tray 10 further includes an engagement hook 30 protruding upward from the bottom wall 20, and a rib 32 protruding upward from the bottom wall 20. The engagement hook 30 is provided in the left portion of the bottom wall 20 in the vicinity of the center portion in the front-rear direction. The rib 32 is provided on the right portion of the bottom wall 20 on the rear side of the center in the front-rear direction. The rib 32 includes a first rib 32a extending longitudinally and a second rib 32b extending rightward from the rear end of the first rib 32a.

A water absorbing sheet 40 made of a nonwoven fabric is provided on the bottom wall 20. In the modified example, the water absorbing sheet 40 may be a woven fabric, a sponge, or the like. The water absorbing sheet 40 is a sheet for sucking water entering the tray 10, and is a sheet for sucking the electrolytic solution leaking from the battery cell case 12 (see FIG. 1). The water absorbing sheet 40 covers substantially the entire surface of the bottom wall 20.

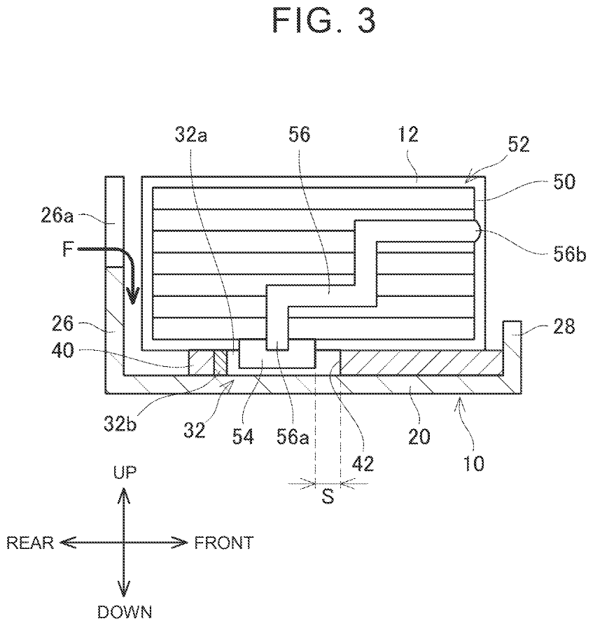

The water absorbing sheet 40 is formed with a first opening portion 42 and a second opening portion 44. The first opening portion 42 is provided at a position corresponding to the rib 32 of the tray 10. The rib 32 is inserted into the first opening portion 42. When the rib 32 is inserted into the first opening portion 42, the left surface of the first rib 32a and the rear surface of the second rib 32b touch the water absorbing sheet 40. As shown in FIG. 3, the height of the rib 32 is the same as the height of the water absorbing sheet 40. In the modified example, the height of the rib 32 may be lower than the height of the water absorbing sheet 40. That is, the upper end of the rib 32 may be positioned lower than the upper end of the water absorbing sheet 40. As shown in FIG. 2, the second opening portion 44 is provided at a position corresponding to the engagement hook 30 of the tray 10. The first opening portion 42 engages with the engagement hook 30. When the first opening portion 42 is engaged with the engagement hook 30, the displacement of the water absorbing sheet 40 with respect to the tray 10 is suppressed.

As shown in FIG. 3, the battery cell case 12 is placed on the bottom wall 20 of the tray 10 via the water absorbing sheet 40. That is, the water absorbing sheet 40 is sandwiched between the tray 10 and the battery cell case 12.

The battery cell case 12 houses a cell module 52 having a plurality of battery cells 50. The battery cell 50 of the present embodiment is a rectangular parallelepiped NiMH battery cell. The battery cell may be a lithium ion battery cell or the like. The plurality of battery cells 50 is stacked in the vertical direction.

On the bottom surface of the cell module 52, a high voltage connection portion 54 protruding downward is provided. The high voltage connection portion 54 is electrically connected to the plurality of battery cells 50. When the battery cell case 12 is placed on the bottom wall 20 of the tray 10, the high voltage connection portion 54 is disposed in the first opening portion 42 of the water absorbing sheet 40. The lower end of the high voltage connection portion 54 is located between the upper end and the lower end of the water absorbing sheet 40. The high voltage connection portion 54 is not in contact with the bottom wall 20 of the tray 10. The high voltage connection portion 54 is surrounded by the first opening portion 42 of the water absorbing sheet 40 via the gap S in the front-rear direction and the left-right direction. That is, the high voltage connection portion 54 is not in contact with the water absorbing sheet 40. The rear end of the high voltage connection portion 54 is located in front of the front end of the second rib 32b of the bottom wall 20. Further, the left end of the high voltage connection portion 54 is located on the right side of the right end of the first rib 32a of the bottom wall 20. That is, the high voltage connection portion 54 does not touch the first rib 32a and the second rib 32b.

One end 56a of the high voltage busbar 56 is electrically connected to the high voltage connection portion 54. A high-voltage wire harness (not shown) is electrically connected to the other end 56b of the high voltage busbar 56. The high-voltage wire harness is electrically connected to a power control unit (PCU), a driving motor, and the like via an electric unit case 14.

As described above, the battery pack 2 includes a tray 10 having a bottom wall 20, a cell module 52 disposed on the tray 10 and having a plurality of battery cells 50, a high voltage connection portion 54 provided on the bottom surface of the cell module 52 and electrically connected to the plurality of battery cells 50, a high voltage busbar 56 connected to the high voltage connection portion 54, and a water absorbing sheet 40 disposed between the bottom wall 20 of the tray 10 and the bottom surface of the cell module 52. The water absorbing sheet 40 is defined with a first opening portion 42 at a position opposite to the high voltage connection portion 54.

In the battery pack 2 of the present embodiment, for example, as indicated by an arrow F in FIG. 3, water may enter the tray 10 through the right cutout portion 26a and the left cutout portion 26b of the rear wall 26 of the tray 10. When water enters the tray 10, the water that has entered the tray 10 is sucked by the water absorbing sheet 40 disposed on the bottom wall 20 of the tray 10. If the water-absorbing sheet is also disposed at a position opposite to the high voltage connection portion 54, the water absorbed by the water absorbing sheet comes into contact with the high voltage connection portion 54. According to the above configuration, the water absorbing sheet 40 is not disposed at a position facing the high voltage connection portion 54. That is, the water absorbing sheet 40 is not in contact with the high voltage connection portion 54. Therefore, it is possible to prevent the water sucked in the water absorbing sheet 40 from coming into contact with the high voltage connection portion 54.

The first opening portion 42 of the tray 10 surrounds the high voltage connection portion 54 via the gap S.

According to the above-described configuration, compared with a configuration in which the first opening portion 42 surrounds the high voltage connection portion 54 without passing through the gap S, it is possible to reduce the possibility that the water absorbed by the water absorbing sheet 40 comes into contact with the high voltage connection portion 54.

Further, the tray 10 may include an engagement hook 30 (an example of an “engaging member”) protruding upward from the bottom wall 20. The water absorbing sheet 40 defines a second opening portion 44 that engages the engagement hook 30.

According to the above configuration, the position of the first opening portion 42 of the water absorbing sheet 40 with respect to the high voltage connection portion 54 can be suppressed from being displaced. Therefore, it is possible to further suppress the water absorbed by the water absorbing sheet 40 from coming into contact with the high voltage connection portion 54.

The tray 10 also includes ribs 32 (an example of “positioning ribs”) that protrude upward from the bottom wall 20 and are disposed on the rear and left sides (an example of “a portion of the periphery”) of the high voltage connection portion 54. The rib 32 is inserted into the first opening portion 42 of the water absorbing sheet 40.

According to the above configuration, the rib 32 of the tray 10 can be used to align the first opening portion 42 of the water absorbing sheet 40 with respect to the high voltage connection portion 54. In addition, the position of the first opening portion 42 of the water absorbing sheet 40 with respect to the high voltage connection portion 54 can be suppressed from being displaced. Therefore, it is possible to further suppress the water absorbed by the water absorbing sheet 40 from coming into contact with the high voltage connection portion 54.

The water absorbing sheet 40 is a nonwoven fabric.

According to the above-described configuration, the water on the tray 10 can be firmly absorbed.

Although the specific examples disclosed by the present disclosure have been described in detail above, these are merely examples and do not limit the scope of claims. The techniques described in the claims include various modifications and alterations of the specific examples illustrated above.

### First Modification

The tray 10 may not have the engagement hook 30. In the present modification, the water absorbing sheet 40 may not have the second opening portion 44.

### (Second Modification)

The ribs 32 of the tray 10 may surround the high voltage connection portion 54.

### (Third Modification)

The tray 10 may not have the ribs 32.

In addition, the technical elements described in the present specification or the drawings exhibit technical usefulness alone or in various combinations, and are not limited to the combinations described in the claims at the time of filing. The technology illustrated in the present specification or the drawings can achieve a plurality of objects at the same time, and has technical usefulness in achieving one of the objects.

What is claimed is:

1. A battery pack comprising:
a tray including a bottom wall;
a cell module that is disposed on the tray and includes at least one battery cell;
a high voltage connection portion that is provided on a bottom surface of the cell module and that is electrically connected to the at least one battery cell;
a high voltage busbar connected to the high voltage connection portion; and
a water absorbing sheet disposed between the bottom wall of the tray and the bottom surface of the cell module, wherein
a first opening portion is defined in the water absorbing sheet at a position facing the high voltage connection portion.

2. The battery pack according to claim 1, wherein the first opening portion surrounds the high voltage connection portion via a gap.

3. The battery pack according to claim 1, wherein:
the tray includes an engaging member that projects upward from the bottom wall; and
a second opening portion that engages with the engaging member is defined on the water absorbing sheet.

4. The battery pack according to claim 1, wherein:
the tray includes a positioning rib that protrudes upward from the bottom wall and that is disposed in a portion around the high voltage connection portion; and
the positioning rib is inserted into the first opening portion of the water absorbing sheet.

5. The battery pack according to claim 1, wherein the water absorbing sheet is a non-woven fabric.
